(19) United States
(12) Patent Application Publication
(10) Pub. No.: US 2011/0215749 A1
(43) Pub. Date: Sep. 8, 2011

(54) ELECTRIC ACTUATOR AND MODULE FOR SUPPLYING POWER DURING A POWER FAILURE

(75) Inventors: Makoto Saruwatari, Tokyo (JP); Hiroaki Narita, Tokyo (JP)

(73) Assignee: Yamatake Corporation, Tokyo (JP)

(21) Appl. No.: 12/968,499

(22) Filed: Dec. 15, 2010

(30) Foreign Application Priority Data
Mar. 5, 2010 (JP) 2010-048767
Mar. 5, 2010 (JP) 2010-048773
Mar. 5, 2010 (JP) 2010-048775
Mar. 5, 2010 (JP) 2010-048777

(51) Int. Cl. H02P 1/18; H02J 9/06

(52) U.S. Cl. 318/453; 307/66

(57) ABSTRACT

An electric actuator is provided having the same configuration whether used as an ordinary electric actuator or as an electric actuator having an emergency shutoff function. A power failure detection circuit, a portion for supplying power during a power failure, a motor power supply switching circuit, a power failure control signal generation circuit, and a control signal switching circuit are provided in a module detachably coupled to the electric actuator. When failure of the primary power is not detected, the motor power supply switching circuit and the control signal switching circuit send the primary power and a signal indicative of a setting of an aperture of a valve of the electric actuator, respectively, to the electric actuator. When failure of the primary power is detected, the motor power supply switching circuit and the control signal switching circuit send the secondary power and the signal indicative of the setting of the aperture during a power failure to the electric actuator.

### CROSS-REFERENCE TO RELATED APPLICATION

This application is being filed concurrently with co-pending patent application No. ______ (attorney docket number 96859/8) and patent application No. ______ (attorney docket number 96859/10), the contents of which are fully incorporated herein by reference.

### FIELD OF THE INVENTION

The present invention relates to systems and methods for supplying power during a power failure; and more particularly to systems and methods including a module for supplying power during a power failure that is used after being connected to an electric actuator that controls a flow by adjusting the aperture of a control target such as a valve, damper, etc.

### BACKGROUND OF THE INVENTION

Conventionally, to adjust the aperture of a control target, an electric actuator is used in air-conditioning equipment, targeting the control of the damper, etc., that adjusts the volume of conditioned air supplied to an air-conditioned area, via valves and ducts provided in the cold- and hot-water piping thereof.

This type of ordinary electric actuator controls operation by providing an alternating current (“AC”) motor as the drive motor within the electric actuator to supply AC power as the operating power supply, and by matching the actual aperture of the control target to the set aperture, in accordance with control instructions from the air-conditioning controller. In an electric actuator operated by such an AC power supply, when the supplied AC power fails, the aperture-controlled control target remains at the operating aperture immediately before power failure, and the appropriate aperture control can no longer be performed.

Therefore, an electric actuator of the following type has also been proposed and already exists: when the AC power supplied to the electric actuator fails, it is forcibly operated to the predetermined aperture (e.g., fully closed), and until the AC power supply returns to the conductive state, the predetermined aperture thereof is maintained. Hereinafter, this type of electric actuator is called an electric actuator having an emergency shutoff function.

As of now, two specific types have been proposed as an electric actuator having an emergency shutoff function: one type is called the spring return type, and the other type is called the secondary power supply drive type.

(Spring return-type electric actuator)

In the spring return-type electric actuator, a return spring biased so as to maintain the fully closed state relative to the drive shaft of the electric actuator is mounted, and when AC power is supplied, the aperture of the control target is adjusted by driving the drive motor against the biasing force of this return spring; and when the power fails, the aperture of the control target is forcibly set to the predetermined aperture by the biasing force of the return spring. An example of a spring return-type electric actuator can be found in Japanese Unexamined Patent Publication No. 2002-174269.

(Secondary power supply drive-type electric actuator)

On the other hand, in the secondary power supply drive-type electric actuator, the drive motor of the electric actuator is a direct current (“DC”) motor; it is separately equipped with a secondary power supply (DC power supply) that comprises a secondary battery, an electric double-layer capacitor, etc.; when AC power is supplied, the aperture of the control target is adjusted by converting this AC power to DC and driving the DC motor; when the power fails, the secondary power supply becomes the operating power supply; and the DC motor is driven by the secondary power supply (DC power supply), thereby forcibly setting the aperture of the control target to the predetermined aperture. An example of the secondary power supply drive-type electric actuator can be found in Japanese Unexamined Patent Publication No. 2008-89109.

However, when these two types of electric actuators having an emergency shutoff function are compared, the spring return-type electric actuator functions as a resistance to the motor drive when the biasing force of the return spring is normal. Therefore, to overcome this resistance, a high-torque motor must be used as the drive motor, which has the disadvantage of increasing the size, weight, and cost of the electric actuator.

In contrast, the secondary power supply drive-type electric actuator lacks the disadvantages of the spring-return type, and is becoming advantageous because of, among other things, recent improvement in the capacitance of the electric double-layer capacitor and the secondary battery, which is the secondary power supply.

In the conventional electric actuator, however, there is considerable structural difference between an electric actuator having an emergency shutoff function and an electric actuator lacking an emergency shutoff function (the ordinary electric actuator), so two types of electric actuators must be produced.

In addition, when a user who has been using the ordinary electric actuator wants later to have the emergency shutoff function in the electric actuator, it is necessary either to considerably remodel the existing electric actuator or to separately purchase an electric actuator having an emergency shutoff function and substitute it for the existing electric actuator, which entails cost or time-consuming remodeling and substitution.

When the ordinary electric actuator is remodeled into a secondary power supply drive-type electric actuator, for example, an AC motor is used as the motor that drives the ordinary electric actuator, it becomes necessary to substitute a DC motor for this AC motor, replace the control board, add a module having an emergency shutoff function, etc. It also is necessary to dispose of the replaced parts. Thus, when an ordinary electric actuator is remodeled into a secondary power supply drive-type electric actuator, the cost and time required for remodeling become excessive.

### SUMMARY OF THE INVENTION

The present invention was developed to solve such problems, and it aims at providing systems and methods pertaining to a module for supplying power during a power failure, that is capable of using an electric actuator having the same configuration as both the ordinary electric actuator and as an electric actuator having the emergency shutoff function.

To attain such an objective, in a module for supplying power during a power failure that is detachably connected via a cable to an electric actuator that comprises an AC motor, an actual aperture detection means that detects the actual aperture of a control target driven by this AC motor, a control means that generates a control output that matches to the set aperture the actual aperture detected by this actual aperture detection means, a drive output signal generation means that receives the control output generated by this control means and generates a drive output signal to the AC motor, an AC power supply input portion that is the energy source of the drive output signal generated by this drive output signal generation means, and a set aperture input means, the present invention comprises an AC power supply relay means that relays AC power to the electric actuator; a power failure detection means that detects failure of the AC power to the electric actuator; a means of supplying power during a power failure that, instead of the AC power supply, acts as the energy source when the power fails; a set aperture relay means that relays the set aperture to the electric actuator; a power failure aperture output means that outputs as the aperture during a power failure the predetermined aperture to be maintained by the control target during a power failure; a power supply selection supply means that selects the AC power relayed by the AC power relay means, as the AC power inputted into the electric actuator, when the power failure detection means does not detect failure of the AC power, and selects the power supply during a power failure from the means of supplying power during a power failure, as the AC power supply inputted into the electric actuator, when the power failure detection means detects failure of the AC power, with the following inputs: the AC power supply relayed by the AC power supply relay means and the power supply during a power failure from the means of supplying power during a power failure; and a set aperture selection and transmission means that selects the set aperture relayed by the set aperture relay means, as the set aperture inputted into the electric actuator when the power failure detection means does not detect failure of the AC power, and selects the aperture during a power failure that is outputted by the power failure aperture output means, as the set aperture inputted into the electric actuator, when the power failure detection means detects failure of the AC power.

When the present invention's module for supplying power during a power failure is not connected to the electric actuator, this electric actuator operates after being supplied with the set aperture and the AC power from the input portion, and control is performed to match the actual aperture of the control target to the set aperture. As a result, this electric actuator functions as an ordinary electric actuator.

When the present invention's module for supplying power during a power failure is connected to the electric actuator, the presence/absence of failure of the AC power to the electric actuator is detected in the module for supplying power during a power failure. If power failure is not detected, the AC power relayed by the AC power relay means and the set aperture relayed by the set aperture relay means are supplied to the electric actuator. If power failure is detected, the power supplied during a power failure from the means of supplying power during a power failure and the aperture during a power failure from the power failure aperture output means are supplied to the electric actuator. As a result, if the power failure does not occur, the electric actuator operates after being supplied with the set aperture and the AC power from the module for supplying power during a power failure, and control is performed to match the actual aperture of the control target to the set aperture. When the power failure occurs, the electric actuator operates after being supplied with the aperture during a power failure and the power supplied during a power failure from the module for supplying power during a power failure, and control is performed to match the actual aperture of the control target to the aperture during power failure (e.g., fully closed). As a result, the electric actuator functions as an electric actuator having an emergency shutoff function. According to the module for supplying power during a power failure of the present invention, when it is not connected to the electric actuator, this electric actuator can be made to function as an ordinary electric actuator; when it is connected to the electric actuator, this electric actuator can be made to function as an electric actuator having an emergency shutoff function; and depending on whether or not the module for supplying power during a power failure is connected, an electric actuator having the same configuration can be used either as an ordinary electric actuator or an electric actuator having an emergency shutoff function

In exemplary embodiments, the systems and methods can include an electric actuator comprising a rotatable shaft and a control means. The control means can generate a first signal used to control a position of the shaft and receive a second signal generated external to the electric actuator indicating a desired position of the shaft. The electric actuator may further receive one of primary power or secondary power, the control means generating the first signal based at least in part on the desired position for the shaft indicated by the second signal. Additionally, the electric actuator may further comprise a motor coupled to the shaft, the motor being responsive to the first signal to adjust the position of the shaft indicated by the third signal.

In one embodiment, the electric actuator can be configured to receive the secondary power externally. Further, the primary power and the secondary power may be of the same type. Still further, in one embodiment, each of the primary power and the secondary power are alternating current power. The electric actuator may further comprise a device coupled to the rotatable shaft for detecting its position. In one embodiment, the device may generate a position signal indicating the position of the shaft. The control means may generate the first signal based at least in part on the position signal. Additionally, in another embodiment, the device may comprise a potentiometer. The device may also generate an arrival signal indicating that the shaft has arrived at a predetermined position. Further, in another embodiment, the control means may generate the first signal based at least in part on the arrival signal. Still further, the device may comprise a limit switch in another alternative embodiment.

In exemplary embodiments, the systems and methods can include a module for supplying power to an electric actuator comprising a detection circuit for generating a first signal indicating whether primary power is being supplied to the module. The module can further comprise a power supply for storing the primary power, the power supply provides secondary power of a similar type as the primary power. Further, the module can additionally comprise a first switching circuit outputting, in response to the first signal, one of a second signal or a third signal external to the module. Still further, the module can also comprise a second switching circuit outputting, in response to the first signal, one of the primary power or the secondary power.

In exemplary embodiments, the systems and methods can include the module for supplying power to an electric actuator where each of the primary power and the secondary power may be alternating current power.

In exemplary embodiments, the systems and methods can include a module for supplying power to an electric actuator comprising a detection circuit generating a first signal indicating whether primary power is being supplied to the module. The module can additionally comprise a first switching circuit outputting, in response to the first signal, one of a second signal generated in response to the first signal and specifying an output for the electric actuator or a third signal.

In exemplary embodiments, the systems and methods can include the module for supplying power to an electric actuator wherein the second signal specifies an output for the electric actuator when primary power is removed from the electric actuator. Additionally, the third signal can be generated external to the module.

In exemplary embodiments, the systems and methods can include the module for supplying power to an electric actuator further comprising a power supply storing primary power supplied to the electric actuator, the power supply provides secondary power of a similar type as the primary power. Still further, the module can comprise a second switching circuit outputting, in response to the first signal, one of the primary power or the secondary power. The module may be configured to provide the output of the first switching circuit external to the module. Alternatively, in one embodiment, the module may be configured to provide the output of the second switching circuit external to the module.

In exemplary embodiments, the systems and methods can include the module for supplying power to an electric actuator wherein the primary power and the secondary power are alternating current power.

In exemplary embodiments, the systems and methods can include an electric actuator system comprising an electric actuator, wherein the electric actuator comprises a rotatable shaft responsive to a first signal that is generated based at least in part on a second signal received from outside the electric actuator. The first signal is generated based at least in part on the desired position for the rotatable shaft indicated by the second signal. The electric actuator system further comprises a module detachably connected to the electric actuator. The module comprises a detection circuit generating a third signal. The module further comprises a power supply storing primary power supplied to the electric actuator. The power supply provides secondary power of a similar type as the primary power. The module also comprises a first switching circuit outputting, in response to the third signal, one of the second signal or a fourth signal. The module also comprises a second switching circuit outputting, in response to the third signal, one of the primary power or the secondary power.

In exemplary embodiments, the systems and methods can include the electric actuator system wherein the second signal specifies a position for the rotatable shaft when primary power is removed from the electric actuator.

In exemplary embodiments, the systems and methods can include the electric actuator system wherein the electric actuator further comprises a device coupled to the rotatable shaft where the device detects a position of the rotatable shaft. Furthermore, the device generates a position signal indicating the position of the rotatable shaft. Additionally, the first signal is generated based at least in part on the position signal. Further still, the device can generate an arrival signal indicating the rotatable shaft has arrived at a predetermined position. Additionally, the first signal is generated based at least in part on the arrival signal.

In exemplary embodiments, a method for providing an electric actuator with a shutoff function can comprise the steps of detecting whether primary power is available to the electric actuator, the detecting step is performed external to the electric actuator; providing primary power to the electric actuator when the detecting step indicates that primary power is available to the electric actuator; switching to secondary power when the detecting step indicates that primary power is not available to the electric actuator; providing a first signal that specifies an output condition for the electric actuator in response to the detecting step indicating that primary power is available to the electric actuator; and switching to a second signal that specifies another output condition for the electric actuator in response to the detecting step indicating that primary power is not available to the electric actuator.

In exemplary embodiments, the method for providing an electric actuator with a shutoff function can comprise the step of deriving the secondary power for the electric actuator from the primary power for the electric actuator where the secondary power is of a similar type as the primary power. Additionally, each of the primary power and the second power can be alternating current power. Furthermore, the deriving step can comprise converting the primary power from alternating current power to direct current power; storing the direct current power; and converting the direct current power to alternating current power.

In exemplary embodiments, the method for providing an electric actuator with a shutoff function can include the electric actuator comprising a rotatable shaft and wherein the step of providing the first signal comprises the step of specifying a position of the rotatable shaft.

In exemplary embodiments, a method for providing an electric actuator with a shutoff function can comprise the steps of generating first and second signals external to the actuator; switching between the first and second signals to select one of the first and second signals to supply to the electric actuator; and generating a third signal internal to the electric actuator based at least in part on the selected one of the first and second signals.

In exemplary embodiments, the method for providing an electric actuator with a shutoff function provides for the first and second signals specifying respective output conditions of the electric actuator. Additionally, the electric actuator comprises a rotatable shaft and the method further comprises the step of generating the third signal in such a way that the position of the rotatable shaft is adjusted to a specified position. Furthermore, the first and second signals specify a respective position of the rotatable shaft. Further still, the method comprises a further step of determining when the rotatable shaft has reached the specified position. Furthermore, one of the first or second signals specifies a position of the rotatable shaft when primary power is not available to the electric actuator. Additionally, the method further comprises the step of determining when the rotatable shaft has reached the specified position.

In exemplary embodiments, the systems and methods can include a module for supplying power during a power failure that is detachably connected via a cable to an electric actuator that comprises an AC motor, an actual aperture detection means that detects the actual aperture of a control target driven by the AC motor, a control means that generates a control output that matches to the set aperture the actual aperture detected by the actual aperture detection means, a drive output generation means that receives the control output generated by the control means and generates a drive output to the AC motor, an AC power supply input portion that is the energy source of the drive output generated by the drive output generation means, and an input portion of the set aperture. The module for supplying power during a power failure can comprise an AC power supply relay means that relays AC power to the electric actuator; a power failure detection means that detects failure of the AC power to the electric actuator; a means of supplying power during a power failure that, instead of the AC power supply, acts as the energy source when the power fails, a set aperture relay means that relays a set aperture to the electric actuator; a power failure aperture output means that outputs, as the aperture during a power failure, a predetermined aperture to be maintained by the control target during a power failure; a power selection supply means that selects the AC power supply relayed by the AC power supply relay means as the AC power inputted into the electric actuator when the power failure detection means does not detect failure of the AC power, that selects the power supplied during a power failure, from the means of supplying power during a power failure, as the AC power inputted into the electric actuator when the power failure detection means detects failure of the AC power, with the following inputs: the AC power relayed by the AC power relay means, and the power supplied during a power failure from the means of supplying power during a power failure; and a set aperture selection and transmission means that selects a set aperture that is relayed by the set aperture relay means as the set aperture inputted into the electric actuator when the power failure detection means fails to detect failure of the AC power, and that selects the set aperture during a power failure, that is outputted by the power failure aperture output means as the set aperture outputted to the electric actuator when the power failure detection means detects failure of the AC power.

In one embodiment, the module for supplying power during a power failure outputs to the power selection supply means the power supply during a power failure, which was created by converting the DC power supply to AC power.

In exemplary embodiments, the systems and methods can include a module for supplying power during a power failure comprising an AC/DC power supply conversion means that converts to DC power the branching input, with the AC power supply relayed by AC power supply relay means as the branching input. The module can also comprise a storage means that stores the charge obtained from the DC power supply converted by the AC/DC power supply conversion means. Further, the module can comprise a DC/AC power supply conversion means that generates a power supply that was converted to AC by using the charge stored in the storage means, and outputs it to the power selection supply means as the power supplied during a power failure.

### BRIEF DESCRIPTION OF THE DRAWINGS

Exemplary embodiments of this invention will be described with reference to the accompanying figures.

FIG. 1 is a block diagram showing the main portion of the electric actuator, before connection of the module for supplying power during a power failure of the present invention.

FIG. 2 is a diagram showing the appearance of this electric actuator.

FIG. 3 is a diagram showing the state in which a first embodiment of the module for supplying power during a power failure of the present invention is connected to this electric actuator.

FIG. 4 is a block diagram of the main portion after connection of the module for supplying power during a power failure, to this electric actuator.

FIG. 5 is a diagram showing the configuration of the interior of the module for supplying power during a power failure.

FIG. 6 is a diagram showing an example in a second embodiment such that the DC/AC power conversion portion in the portion for supplying power during a power failure comprises a class D amplifier and a power supply filter, in the first embodiment.

Next, embodiments of the module during a power failure of the present invention will be described in detail, based on the drawings.

### DETAILED DESCRIPTION OF THE EXEMPLARY EMBODIMENTS

(Electric actuator)

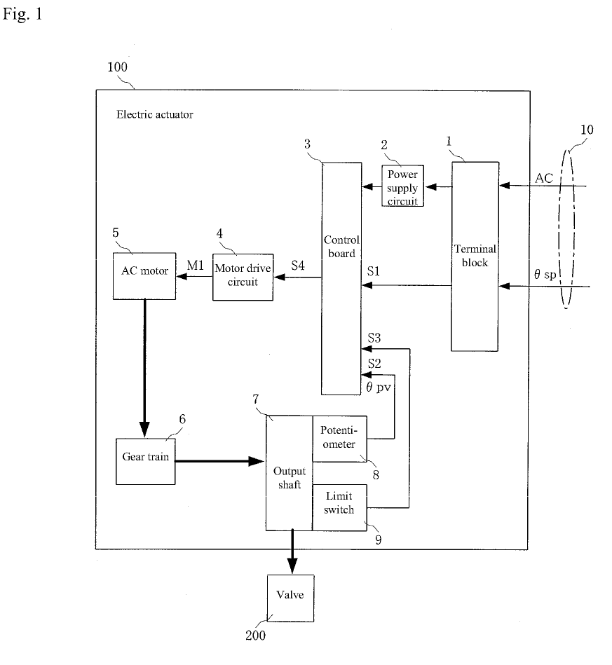

FIG. 1 is a block diagram showing the main portion of the electric actuator before connection of the module for supplying power during a power failure of the present invention. In the figure, 100 is an electric actuator, and 200 is a valve (control target) whose aperture is controlled by this electric actuator 100.

The electric actuator 100 comprises a terminal block 1, a power supply circuit 2, a control board 3, a motor drive circuit 4, an AC motor 5, a gear train 6 that transmits the driving force of the AC motor 5, an output shaft 7 that adjusts the aperture of the valve 200 as the output terminal of this gear train 6, a potentiometer 8 that detects the rotation angle position of this output shaft 7 as the actual aperture θ pv of the valve 200, and a limit switch 9 that detects the arrival at a predetermined rotation angle position of the output shaft 7.

In this electric actuator 100, the AC power supply is inputted at the terminal block 1 as the operating power supply from the exterior, and this AC power supply becomes the required internal power supply in the power supply circuit 2, after which it is supplied to the control board 3. In addition, in the terminal block 1, the set aperture θ sp is inputted as a control instruction from an air-conditioning controller (not shown), and this inputted set aperture θ sp is sent to the control board 3 as a set aperture signal S1. Also, in the control board 3, the valve 200's actual aperture θ pv from the potentiometer 8 is provided as an actual aperture detection signal S2, and the signal from the limit switch 9, which indicates arrival of the output shaft 7 at the predetermined rotation angle position, is provided as the predetermined rotation angle position arrival signal S3.

The control board 3 receives the set aperture signal Si from the air-conditioning controller and the actual aperture detection signal S2 from the potentiometer 8, generates a control output S4 that matches the actual aperture θ pv of the valve 200 to the set aperture θ sp, and sends this generated control output S4 to the motor drive circuit 4. The motor drive circuit 4 receives the control output S4 from the control board 3, and generates a drive output signal M1 to the AC motor 5.

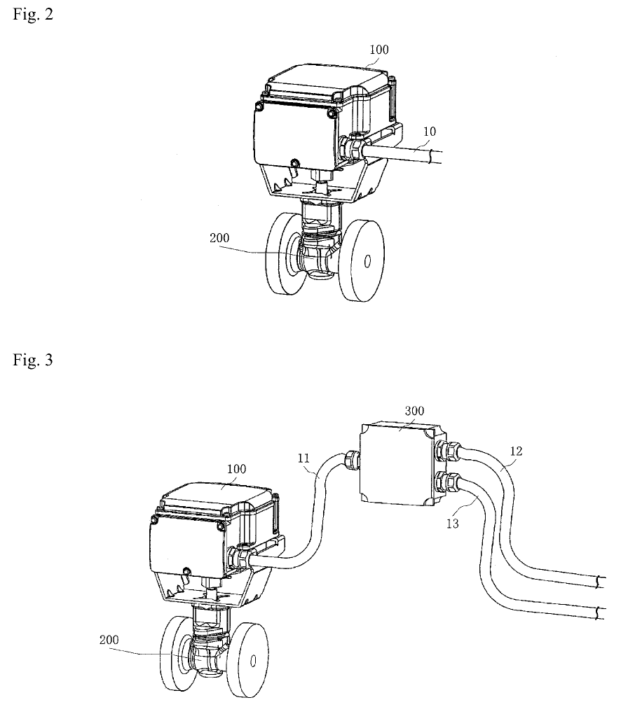

FIG. 2 is a diagram showing the appearance of this electric actuator 100. In the figure, 10 is the power line and the signal line that leads the AC power supply and the set aperture θ sp into the interior of the electric actuator 100.

In this electric actuator 100, the drive output signal M1 generated by the motor drive circuit 4 is sent to the AC motor 5, and control is performed so as to match the actual aperture θ pv of the valve 200 to the set aperture θ sp. In this manner, this electric actuator 100 functions as the ordinary electric actuator.

(When it is used as an electric actuator having an emergency shutoff function)

When it is desired to use this electric actuator 100 as an electric actuator having an emergency shutoff function, as shown in FIG. 3, a module 300 for supplying power during a power failure is connected, via a cable 11, between the electric actuator 100 and the power line 12 and the signal line 13.

That is, the current and signal lines 10 are detached from the electric actuator 100, the power line 12 and the signal line 13 are connected to the input side of the module 300, and the cable 11 is used to connect the output side of the module 300 and the input side of the electric actuator 100.

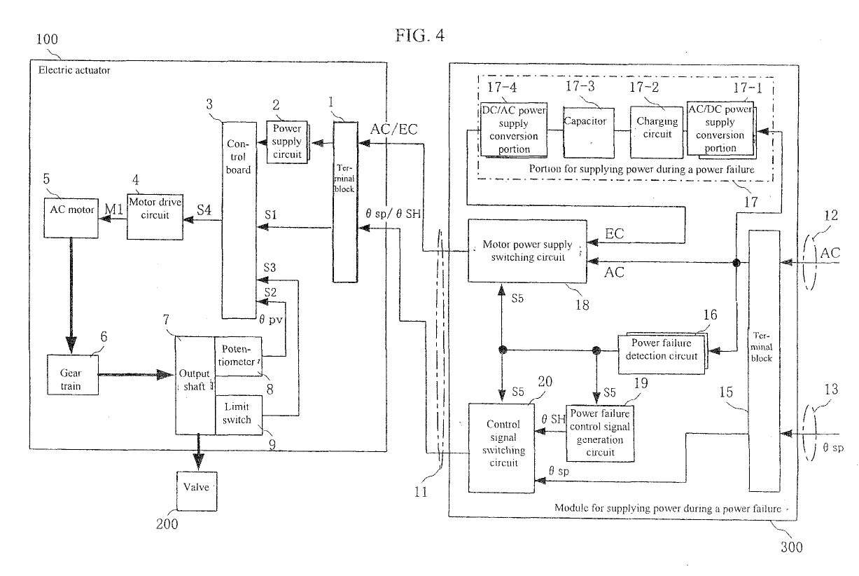

FIG. 4 is a block diagram of the main portion when the module 300 is connected to the electric actuator 100. The module 300 is one embodiment in the first embodiment of the power failure module of the present invention, and it comprises a terminal block 15, a power failure detection circuit 16, a portion for supplying power during a power failure 17, a motor power supply switching circuit 18, a power failure control signal generation circuit 19, and a control signal switching circuit 20.

When this module 300 is connected to the electric actuator 100, the power line 12 and the signal line 13 are connected to the terminal block 15 in the module 300, the AC power supply AC relayed by this terminal block 15 is sent to the motor power supply switching circuit 18, and the set aperture θ sp relayed by this terminal block 15 is sent to the control signal switching circuit 20.

In the module 300, the power failure detection circuit 16 monitors the AC power supply AC relayed by the terminal block 15, and outputs the power failure detection yes/no signal S5, which notifies of the presence/absence of failure of the AC power supply AC.

The portion 17 for supplying power during a power failure comprises an AC/DC power supply conversion portion 17-1 that converts to DC power supply to the branching input, with the AC power supply relayed by the terminal block 15 as the branching input; a charging circuit 17-2 that operates after receiving the DC power supply converted by the AC/DC power supply conversion portion 17-1; a capacitor (electric double-layer capacitor or lithium ion capacitor) 17-3 charged by this charging circuit 17-2; and a DC/AC power supply conversion portion 17-4 that generates the AC power supply by using the charge stored in the capacitor 17-3, and outputs it as the secondary power EC. Furthermore, an inverter is used as the DC/AC power supply conversion portion 17-4.

With the AC power supply AC sent from the terminal block 15 and the secondary power EC sent by the portion 17 for supplying power during a power failure as inputs, and based on the power failure detection yes/no signal S5 from the power failure detection circuit 16, the motor power supply switching circuit 18 selects the AC power supply AC sent from the terminal block 15 as the AC power supplied to the electric actuator 100, when the power failure detection circuit 16 does not detect failure of the AC power supply AC, and selects the secondary power EC sent from the portion 17 for supplying power during a power failure as the AC power supplied to the electric actuator 100, when the power failure detection circuit 16 detects failure of the AC power supply AC. The selected AC power supply from the motor power supply switching circuit 18 is sent to the terminal block 1 of the electric actuator 100.

Based on the power failure detection yes/no signal S5 from the power failure detection circuit 16, when the power failure detection circuit 16 detects failure of the AC power supply AC, the power failure control signal generation circuit 19 outputs, as the aperture during power failure θ SH (the power failure control signal), the predetermined aperture to be maintained by the valve 200 when the power fails.

With the set aperture θ sp sent from the terminal block 15 and the aperture during power failure θ SH sent from the power failure control signal generation circuit 19 as inputs, and based on the power failure detection yes/no signal S5 from the power failure detection circuit 16, the control signal switching circuit 20 selects the set aperture θ sp sent from the terminal block 15 as the set aperture inputted into the electric actuator 100, when the power failure detection circuit 16 does not detect failure of the AC power supply AC, and selects the aperture during power failure θ SH sent from the power failure control signal generation circuit 19 as the set aperture inputted into the electric actuator 100, when the power failure detection circuit 16 detects failure of the AC power supply AC. The selected set aperture from the control signal switching circuit 20 is sent to the terminal block 1 of the electric actuator 100, as the set aperture signal (control signal) S1.

In this case, the cable 11 that connects the module 300 and the electric actuator 100 comprises: the relay lines for the secondary power EC and the AC power supply AC, which are selectively sent from the motor power supply switching circuit 18, and the relay lines for the set aperture θ sp and the aperture during power failure θ SH, which are selectively sent from the control signal switching circuit 20.

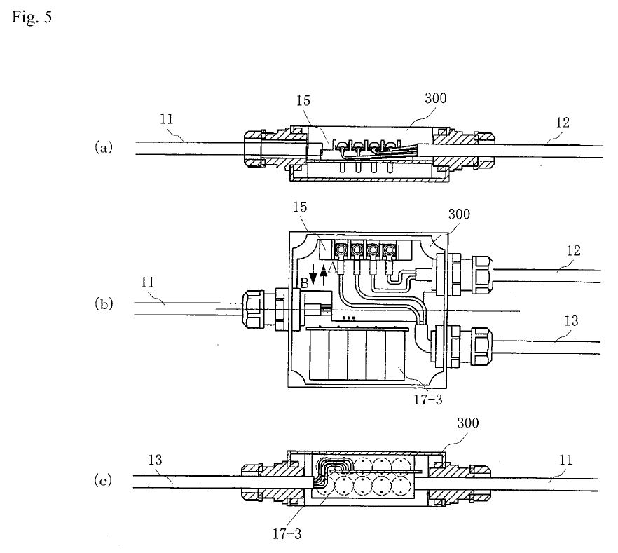

FIG. 5 shows the configuration of the interior of the module 300. FIG. 5(b) is a diagram showing the interior after opening the cover of the module 300. FIG. 5(a) is a diagram of the terminal block 15 side in FIG. 5(b), as viewed in direction A. FIG. 5(c) is a diagram of the capacitor 17-3 side in FIG. 5(b), as viewed in direction B. A plurality of capacitors (electric double-layer capacitors, lithium ion capacitors) 17-3 are provided in the module 300, to assure high-capacity power supply during a power failure.

(When the power does not fail)

When the AC power supply AC to the electric actuator 100 does not fail, the motor power supply switching circuit 18 in the module 300 selects, as the AC power supplied to the electric actuator 100, the AC power supply AC sent from the terminal block 15, based on the power failure detection yes/no signal S5 from the power failure detection circuit 16. The selected AC power supply AC from the motor power supply switching circuit 18 is sent to the terminal block 1 of the electric actuator 100.

In addition, when the AC power supply AC to the electric actuator 100 does not fail, and based on the power failure detection yes/no signal S5 from the power failure detection circuit 16, the control signal switching circuit 20 in the module 300 selects the set aperture θ sp sent from the terminal block 15, as the set aperture inputted into the electric actuator 100. The selected set aperture θ sp from the control signal switching circuit 20 is sent to the terminal block 1 of the electric actuator 100.

As a result, when the AC power supply AC to the electric actuator 100 does not fail, the drive output signal M1 from the motor drive circuit 4 is generated in the electric actuator 100, with the AC power supply AC as the energy source, and control is performed to match the actual aperture θ pv of the valve 200, to the set aperture θ sp.

(When the power fails)

When the AC power supply AC to the electric actuator 100 fails, the motor power supply switching circuit 18 in the module 300 selects, as the AC power supplied to the electric actuator 100, the secondary power EC from the portion 17 for supplying power during a power failure, based on the power failure detection yes/no signal S5 from the power failure detection circuit 16. The selected power supply during a power failure EC from the motor power supply switching circuit 18 is sent to the terminal block 1 of the electric actuator 100.

In addition, when the AC power supply AC to the electric actuator 100 fails, and based on the power failure detection yes/no signal S5 from the power failure detection circuit 16, the control signal switching circuit 20 in the module 300 selects the aperture during power failure θ SH from the power failure control signal generation circuit 19, as the set aperture inputted into the electric actuator 100. The selected aperture during power failure θ SH from the control signal switching circuit 20 is sent to the terminal block 1 of the electric actuator 100.

As a result, when the AC power supply AC fails, in the electric actuator 100, the drive output signal M1 from the motor drive circuit 4 is generated, with the secondary power EC as the energy source, and control is performed to match the actual aperture θ pv of the valve 200 to the aperture during a power failure θ SH.

Furthermore, in the present example, when the power failure detection circuit 15 detects failure of the AC power supply, the power failure control signal generation circuit 19 outputs the aperture during a power failure θ SH. However, regardless of whether or not a power failure is detected, the aperture during a power failure θ SH may be configured in advance so as to always be supplied to the control signal switching circuit 20.

(When power is restored)

In the module 300, monitoring of the AC power supply in the power failure detection circuit 16 continues even after the AC power supply fails, by using the secondary power EC generated by the portion 17 for supplying power during a power failure. When AC power supply is restored, the power failure detection circuit 16 notifies the motor power supply switching circuit 18, the power failure control signal generation circuit 19, and the control signal switching circuit 20 of the fact, by using the power failure detection yes/no signal S5.

When notified by the power failure detection circuit 16 of the fact that AC power supply has been restored, the motor power supply switching circuit 18 selects the AC power supply sent from the terminal block 15, as the AC power supplied to the electric actuator 100. The selected AC power supply from the motor power supply switching circuit 18 is sent to the terminal block 1 of the electric actuator 100.

In addition, when notified by the power failure detection circuit 16 of the fact that AC power supply has been restored, the control signal switching circuit 20 selects the set aperture θ sp sent from the terminal block 15, as the set aperture inputted into the electric actuator 100. The selected set aperture θ sp from the control signal switching circuit 20 is sent to the terminal block 1 of the electric actuator 100.

As a result, when the AC power supply is restored, as before power failure the drive output signal M1 from the motor drive circuit 4 is generated, with the AC power supply as the energy source, in the electric actuator 100, and control is performed to match the actual aperture θ pv of the valve 200 to the set aperture θ sp.

Thus, when the module 300 is connected to the electric actuator 100, the electric actuator 100, which had until then functioned as an ordinary actuator, begins to function as an electric actuator having an emergency shutoff function.

In this electric actuator 100, the terminal block 1 corresponds to the input portion of the set aperture and the AC power supply of the present invention; the control board 3 corresponds to the control means; the motor drive circuit 4 corresponds to the drive output signal generation means; the AC motor 5 corresponds to the AC motor; and the potentiometer 8 corresponds to the actual aperture detection means. In addition, in the module 300, the terminal block 15 corresponds to the set aperture relay means and the AC power supply relay means of the present invention; the power failure detection circuit 16 corresponds to the power failure detection means; the portion 17 for supplying power during a power failure corresponds to the means of supplying power during a power failure; the motor power supply switching circuit 18 corresponds to the power supply selection supply means; the power failure control signal generation circuit 19 corresponds to the power failure aperture output means; and the control signal switching circuit 20 corresponds to the set aperture selection and transmission means.

As aforementioned, according to the module 300 of the present embodiment, when it is not connected to electric actuator 100, it causes the electric actuator 100 to function as an ordinary electric actuator; and when it is connected to the electric actuator 100, it causes the electric actuator 100 to function as an electric actuator having an emergency shutoff function.

In this case, the cable 11, the power line 12, and the signal line 13 must be connected, but the electric actuator 100 need not be remodeled; and by either connecting or not connecting the module 300, it is possible to use an electric actuator 100 having the same configuration either as an ordinary electric actuator or as an electric actuator having an emergency shutoff function.

As a result, manufacturers need not produce two types of electric actuators. In addition, it becomes possible to simply change on site from an ordinary electric actuator to an electric actuator having an emergency shutoff function.

Also, in this example, the electric actuator 100 becomes the secondary power supply drive type. Therefore, it becomes unnecessary to increase drive motor capacity and strengthen gears for the amount of absent biasing force of the return spring, compared with the spring return type. In addition, the module 300 can be positioned at an arbitrary position, so it becomes possible to change the electric actuator 100 to an electric actuator having an emergency shutoff function, even in a confined space.

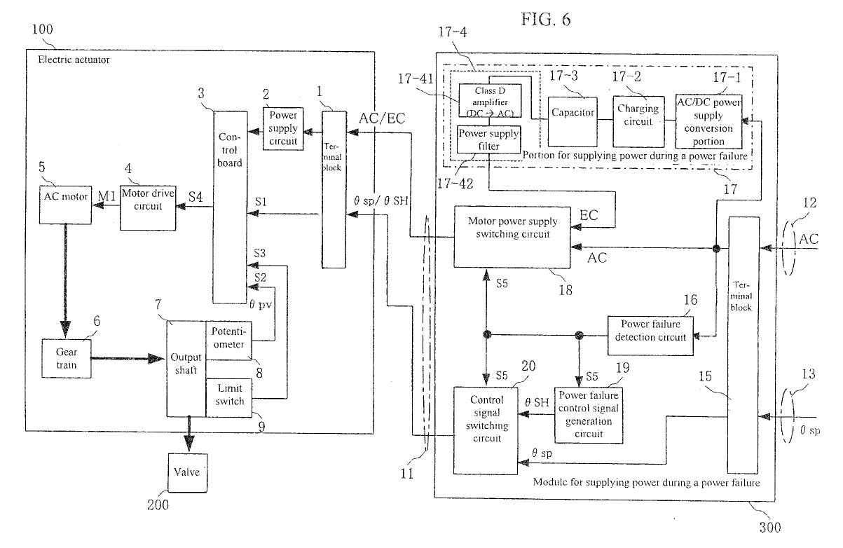

Moreover, the aforementioned first embodiment is such that an inverter is used as the DC/AC power supply conversion portion 17-4 in the portion 17 for supplying power during a power failure. However, as shown in FIG. 6 as the second embodiment, the DC/AC power supply conversion portion 17-4 may comprise a class D amplifier (DC→AC) 17-41 and a power supply filter 17-42, or it may be configured with an AC power amplifier.

Furthermore, in the aforementioned example, the portion 17 for supplying power during a power failure in the module 300 is configured by using a capacitor (e.g., electric double-layer capacitor, lithium ion capacitor). However, a lithium battery or other secondary battery may also be used, and a primary battery may also be used. Thus, various devices such as a non-rechargeable battery (e.g., primary battery), a rechargeable battery (e,g,, secondary battery), electric double-layer capacitor, etc., can be used as the means of generating the secondary power EC, and they can be used by selecting appropriately.

### INDUSTRIAL APPLICABILITY

The module for supplying power during a power failure of the present invention can be used in various fields, such as air-conditioning equipment, as a module for supplying power during a power failure that is connected to an electric actuator that controls a flow by adjusting the aperture of a control target, such as a valve, damper, etc.

### Description of the Symbols

1 Terminal block, 2 Power supply circuit, 3 Control board, 4 Motor drive circuit, 5 AC motor, 6 Gear train, 7 Output shaft, 8 Potentiometer, 9 Limit switch, 10 Current & signal lines, 11 Cable, 12 Power line, 13 Signal line, 15 Terminal block, 16 Power failure detection circuit, 17 Portion for supplying power during a power failure, 17-1 AC/DC power supply conversion portion, 17-2 Charging circuit, 17-3 Capacitor (, electric double-layer capacitor, lithium ion capacitor), 17-4 DC/AC power supply conversion portion, 17-41 Class D amplifier, 17-42 Power supply filter, 18 Motor power supply switching circuit, 19 Power failure control signal generation circuit, 20 Control signal switching circuit, 100 Electric actuator, 200 Valve, 300 Module for supplying power during a power failure.

What is claimed is:

1. A module for supplying power to an electric actuator, comprising:
a detection circuit for generating a first signal indicating whether primary power is being supplied to the module;
a power supply for storing the primary power, the power supply providing secondary power of a similar type as the primary power;
a first switching circuit outputting, in response to the first signal, one of a second signal or a third signal external to the module; and
a second switching circuit outputting, in response to the first signal, one of the primary power or the secondary power.

2. The module of claim 1, wherein each of the primary power and the secondary power are alternating current power.

3. A module for supplying power to an electric actuator, comprising:
a detection circuit generating a first signal indicating whether primary power is being supplied to the module; and
a first switching circuit outputting, in response to the first signal, one of a second signal generated in response to the first signal and specifying an output for the electric actuator or a third signal.

4. The module of claim 3, wherein the second signal specifies an output for the electric actuator when primary power is removed from the electric actuator.

5. The module of claim 3, wherein the third signal is generated external to the module.

6. The module of claim 3, further comprising:
a power supply storing primary power supplied to the electric actuator, the power supply providing secondary power of a similar type as the primary power; and
a second switching circuit outputting, in response to the first signal, one of the primary power or the secondary power.

7. The module of claim 6, wherein the module is configured to provide the output of the first switching circuit external to the module.

8. The module of claim 6, wherein the module is configured to provide the output of the second switching circuit external to the module.

9. The module of claim 3, wherein each of the primary power and the secondary power are alternating current power.

10. An electric actuator system, comprising:
an electric actuator, wherein the electric actuator comprises a rotatable shaft responsive to a first signal that is generated based at least in part on a second signal received from outside the electric actuator, the first signal being generated based at least in part on the desired position for the rotatable shaft indicated by the second signal; and
a module detachably connected to the electric actuator, wherein the module comprises:
a detection circuit generating a third signal;
a power supply storing primary power supplied to the electric actuator, the power supply providing secondary power of a similar type as the primary power;
a first switching circuit outputting, in response to the third signal, one of the second signal or a fourth signal; and
a second switching circuit outputting, in response to the third signal, one of the primary power or the secondary power.

11. The electric actuator system of claim 10, wherein the second signal specifies a position for the rotatable shaft when primary power is removed from the electric actuator.

12. The electric actuator system of claim 10, wherein the electric actuator further comprises a device coupled to the rotatable shaft, the device detecting a position of the rotatable shaft.

13. The electric actuator system of claim 12, wherein the device generates a position signal indicating the position of the rotatable shaft.

14. The electric actuator system of claim 13, wherein the first signal is generated based at least in part on the position signal.

15. The electric actuator system of claim 14 wherein the device generates an arrival signal indicating that the rotatable shaft has arrived at a predetermined position.

16. The electric actuator system of claim 15, wherein the first signal is generated based at least in part on the arrival signal.

17. A method for providing an electric actuator with a shutoff function, the method comprising the steps of:
detecting whether primary power is available to the electric actuator, the detecting step being performed external to the electric actuator;
providing primary power to the electric actuator when the detecting step indicates that primary power is available to the electric actuator;
switching to secondary power when the detecting step indicates that primary power is not available to the electric actuator;
providing a first signal that specifies an output condition for the electric actuator in response to the detecting step indicating that primary power is available to the electric actuator; and
switching to a second signal that specifies another output condition for the electric actuator in response to the detecting step indicating that primary power is not available to the electric actuator.

18. The method of claim 17 further comprising the step of:
deriving the secondary power for the electric actuator from the primary power for the electric actuator, the secondary power being of a similar type as the primary power.

19. The method of claim 18, wherein each of the primary power and the secondary power are alternating current power.

20. The method of claim 19, wherein the deriving step comprises:
converting the primary power from alternating current power to direct current power;
storing the direct current power; and
converting the direct current power to alternating current power.

21. The method of claim 17 wherein the electric actuator comprises a rotatable shaft, wherein the step of providing the first signal comprises the step of specifying a position of the rotatable shaft.

22. A method for providing an electric actuator with a shutoff function, the method comprising the steps of:
generating first and second signals external to the actuator;
switching between the first and second signals to select one of the first and second signals to supply to the electric actuator; and
generating a third signal internal to the electric actuator based at least in part on the selected one of the first and second signals.

23. The method of claim 22, wherein the first and second signals specify respective output conditions of the electric actuator.

24. The method of claim 23, wherein:
the electric actuator comprises a rotatable shaft; and
the method further comprises the step of:
generating the third signal in such a way that the position of the rotatable shaft is adjusted to a specified position.

25. The method of claim 24, wherein the first and second signals specify a respective position of the rotatable shaft.

26. The method of claim 25, further comprising the step of determining when the rotatable shaft has reached the specified position.

27. The method of claim 26, wherein one of the first or second signals specifies a position of the rotatable shaft when primary power is not available to the electric actuator.

28. The method of claim 27, further comprising the step of determining when the rotatable shaft has reached the specified position.
